(19) United States
(12) Patent Application Publication
(10) Pub. No.: US 2008/0158501 A1
(43) Pub. Date: Jul. 3, 2008

(54) Polarizing plate and method for producing the same

(75) Inventors: Yuki Matsunami, Kanagawa (JP); Koh Kamada, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/004,418

(22) Filed: Dec. 21, 2007

(30) Foreign Application Priority Data
Dec. 27, 2006 (JP) 2006-351424

(51) Int. Cl. G02B 5/30; G02F 1/13

(52) U.S. Cl. 349/194; 430/20; 977/777

(57) ABSTRACT

To provide a polarizing plate including a polarizing layer containing anisotropic metal nanoparticles produced by reducing a metal ion in a liquid crystal matrix. An embodiment in which the liquid crystal matrix is characterized in that molecules of a liquid crystal compound are fixed in an alignment state of any one of substantially horizontal alignment, substantially vertical alignment, diagonal alignment, hybrid alignment and spiral alignment; an embodiment in which the reduction is at least one of photoreduction, thermal reduction and chemical reduction; and the like are favorable.

### BACKGROUND OF THE INVENTION

1. Field of the Invention

The present invention relates to a polarizing plate which has superior polarizing properties over a wide wavelength range and which is superior in weather resistance, and a method for producing the polarizing plate efficiently.

2. Description of the Related Art

Conventionally, as a method for producing a polarizing plate containing anisotropic metal nanoparticles as alignment elements, there has been proposed a method that includes the steps of dispersing metal compound nanoparticles into glass, uniaxially stretching the glass at a temperature higher than or equal to the glass softening temperature such that the nanoparticles become anisotropic, and thermally decomposing them or reducing them with hydrogen gas to form anisotropic metal nanoparticles (refer to Japanese Patent Application Laid-Open (JP-A) No. 2003-279749). In this proposal, since the draw ratio of the glass is great, it is possible to produce a polarizing plate with a high degree of alignment. However, high heat with a temperature that is higher than or equal to the glass softening temperature is required in the production step, and the polarizing plate becomes difficult to handle unless it is thick to some extent, which hinders the thinning of the polarizing plate. Further, there is a problem that the glass is liable to break when being used.

Accordingly, as inventions with which handleability of a polarizing plate is improved by changing the matrix from glass to an organic polymer, there have been proposed methods for forming anisotropic metal nanoparticles that include the steps of applying into an organic polymer matrix a mixture solution of a polyamic acid and a metal salt, heating the solution after stretching the matrix for polyimidization, and thermally reducing the solution simultaneously to reduce a metal ion (refer to JP-A Nos. 08-184701 and 2006-184624). According to these proposals, since polyimide has high alignment properties and heat resistance, it is possible to produce a polarizing plate with a high degree of alignment. The polyimidizing step, however, requires a temperature of 300° C. or greater, and thereby complex and large manufacturing apparatus is required. Also, since high heat is applied, particles are liable to change into a spherical form by the heat even after they have developed into a rod-like form, and there is a problem that it is difficult to control their aspect ratio. Further, there is a problem that the wavelength range in which polarizing properties of the polarizing plate obtained are shown is narrow.

Meanwhile, there has been proposed a method for forming metal particles that includes the steps of mixing together polyvinyl alcohol and a metal salt, stretching the formed film, and reducing metal ions by irradiation with light, with the polymeric chains being aligned (refer to JP-A No. 2006-284921).

In the method proposed, however, there is a problem that it is difficult to develop metal particles such that they are kept in a rod-like form, and also there is a problem that the wavelength range in which polarizing properties of a polarizing plate obtained are shown is narrow.

Additionally, JP-A No. 2004-212942 proposes a polarizer in which metal fine particles are dispersed into a matrix formed of a liquid crystal material. This literature suggests that the metal fine particles have an average particle diameter of 100 nm or less and an aspect ratio (maximum length/minimum length) of 2 or less. In this proposal, however, the birefringence of the liquid crystal matrix itself is utilized as a polarizing property, and the metal fine particles are spherical and therefore do not have anisotropy, hence there is a problem that the wavelength range in which polarizing properties are shown is narrow. Also, since a stretching process is conducted, stretch equipment is required, hence there is a problem it results in poor productivity and increased costs.

As methods for producing vertically aligned polarizers, there are a method of using an anodized alumina film and a method of using oblique evaporation.

The method of using an anodized alumina film is a method for forming metal nanorods having a diameter of several tens of nanometers and an aspect ratio of 1 or more in an alumina dielectric substance by anodizing an aluminum layer of 10 nm to 5,000 nm in thickness deposited over a transparent substrate made of, for example, glass, provided with a conductive film such as an ITO film so that minute holes of several tens of nanometers in diameter are created at intervals, and conducting an electrolytic/electroless plating process to fill the holes with a metal such as gold or silver (refer to pp. 20-24 of Nanotechnology by L. D. Zhang et al. in 2003).

The oblique evaporation method is a method for forming a columnar structure of a metal in a self-organizing manner by placing a transparent substrate at an oblique angle to an evaporation source (refer to J. Appl. Phys. 100, 063527 by Z.-Y. Zhang et al. in 2006).

However, the method of using an anodized alumina film involves a large number of steps including evaporation of an ITO film, evaporation of an aluminum film, formation of minute holes by anodization and filling of the holes with a metal by plating, and thus there is such a drawback that this method is costly, and area enlargement becomes difficult to achieve. Meanwhile, the oblique evaporation method may make it possible to control an angle of alignment by changing the evaporation angle of an aluminum film; however, it is technically difficult to achieve. Also, in the oblique evaporation method, since a substrate is placed at an oblique angle to an evaporation source, it is difficult to form a vertical-type polarizer. Additionally, although it is possible to produce an oblique-type polarizer, a metal nanorod lies exposed, and thus there is a problem that this polarizer is low in scratch resistance and also low in the resistance to oxidation, etc.

### BRIEF SUMMARY OF THE INVENTION

An object of the present invention is to provide a polarizing plate which has superior polarizing properties over a wide wavelength range and which is superior in weather resistance, and a method for producing the polarizing plate inexpensively and efficiently.

Means for solving the problems are as follows.

<1> A polarizing plate including: a polarizing layer containing anisotropic metal nanoparticles produced by reducing a metal ion in a liquid crystal matrix.

The polarizing plate according to <1> includes a polarizing layer containing anisotropic metal nanoparticles produced by reducing a metal ion in a liquid crystal matrix, and the anisotropic metal nanoparticles are deposited in an aligned manner with the liquid crystal matrix serving as a place for alignment. The anisotropic metal nanoparticles exhibit surface plasmon resonance, exhibit polarizing properties according to the difference in absorption wavelength between the minor axis and the major axis, notably superior polarizing properties over a wide wavelength range, and improve light resistance.

<2> The polarizing plate according to <1>, wherein in the liquid crystal matrix molecules of a liquid crystal compound are fixed in an alignment state of any one of a substantially horizontal alignment, substantially vertical alignment, diagonal alignment, hybrid alignment and spiral alignment.

<3> The polarizing plate according to <1>, wherein the reduction is at least one of photoreduction, thermal reduction and chemical reduction.

<4> The polarizing plate according to <2>, wherein the anisotropic metal nanoparticles have an average aspect ratio of greater than 1, and the major axis of the anisotropic metal nanoparticles is aligned in the alignment direction of the molecules of the liquid crystal compound in the liquid crystal matrix.

<5> The polarizing plate according to <1>, wherein the anisotropic metal nanoparticle is an aggregate composed of two or more substantially spherical metal nanoparticles.

<6> The polarizing plate according to <1>, wherein the anisotropic metal nanoparticle comprises at least one element selected from silver, gold, copper, aluminum, palladium, rhodium, platinum, ruthenium, selenium, tellurium, cobalt and nickel.

<7> The polarizing plate according to <1>, including a base and a polarizing layer on the base, wherein the major axis of the anisotropic metal nanoparticles is aligned in any one of a substantially horizontal direction, substantially vertical direction, diagonal direction, hybrid direction and spiral direction, with respect to a base surface.

<8> The polarizing plate according to <7>, wherein the major axis of the anisotropic metal nanoparticles is aligned in any one of the substantially horizontal direction and substantially vertical direction, with respect to the base surface.

<9> A method for producing a polarizing plate, including: forming a liquid crystal film where molecules of the liquid crystal compound are fixed in an alignment state by applying a liquid crystal composition containing at least a liquid crystal compound onto a base whose surface is provided with an alignment film and by curing the liquid crystal composition; impregnating the liquid crystal film with a metal ion; and reducing the metal ion in the liquid crystal film so as to form anisotropic metal nanoparticles.

As to the method for producing a polarizing plate according to <9>, although high temperatures (the softening point of glass and the polymerization reaction temperature of polyimide), extending equipment at the high temperatures, and combustion gases such as hydrogen gas have been conventionally required, the method of the present invention for producing a polarizing plate makes it possible to utilize existing liquid crystal cured film manufacturing equipment and thus to produce a large-area polarizing plate inexpensively. In addition, any one of a substantially horizontal direction polarizer, substantially vertical direction polarizer, diagonal direction polarizer, hybrid direction polarizer and spiral direction polarizer can be produced.

<10> The method for producing a polarizing plate according to <9>, wherein the reduction is at least one of photoreduction, thermal reduction and chemical reduction.

### BRIEF DESCRIPTION OF THE SEVERAL VIEWS OF THE DRAWINGS

FIG. 1 is a figure showing the absorption spectrum of an anisotropic metal nanoparticle.

FIG. 2A is a schematic diagram showing a rod-like anisotropic metal nanoparticle.

FIG. 2B is a schematic diagram showing substantially spherical anisotropic metal nanoparticles in a flocculated state.

FIG. 3 is a TEM photograph showing a section of a polarizing plate of Example 1 observed using a transmission electron microscope (TEM).

### DETAILED DESCRIPTION OF THE INVENTION

### (Polarizing Plate)

The polarizing plate of the present invention includes at least a polarizing layer, includes a base and an alignment film, and further includes additional layer(s) according to necessity.

### <Polarizing Layer>

The polarizing layer contains anisotropic metal nanoparticles produced by reducing a metal ion in a liquid crystal matrix, contains a liquid crystal compound, a polymerization initiator and an aligning agent, and further contains additional components according to necessity.

### —Liquid Crystal Matrix—

The liquid crystal matrix serves as a place for forming anisotropic metal nanoparticles from a metal ion; for example, it is desirable that molecules of a liquid crystal compound be fixed in an alignment state of any one of a substantially horizontal alignment, substantially vertical alignment, diagonal alignment, hybrid alignment and spiral alignment.

A liquid crystal in the liquid crystal matrix is not particularly limited and can be suitably selected according to the purpose; however, a curable liquid crystal compound is favorable, and any one of a thermosetting liquid crystal compound and an ultraviolet-curable liquid crystal compound can be used, with an ultraviolet-curable liquid crystal compound being particularly favorable amongst them.

The ultraviolet-curable liquid crystal compound is not particularly limited and can be suitably selected according to the purpose as long as it has a polymerizable group and is cured by ultraviolet irradiation; suitable examples thereof include the ones represented by the following structural formulae.

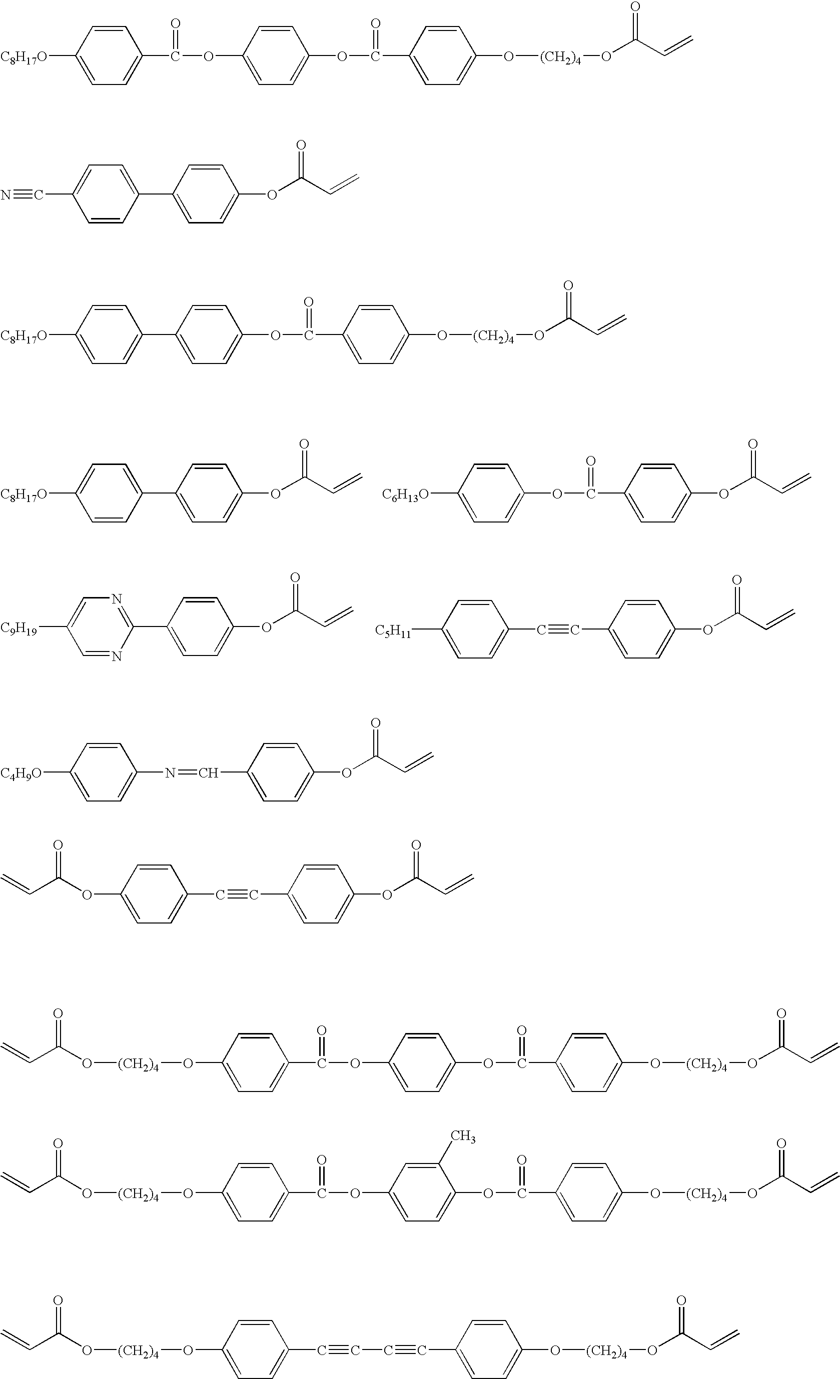

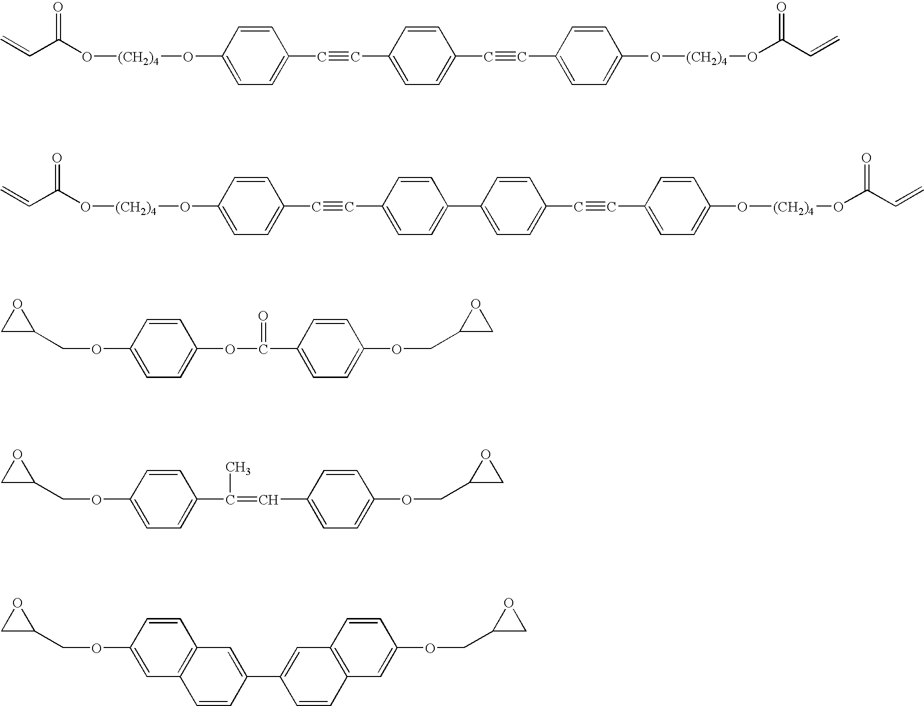

Commercially-supplied products can be used for the liquid crystal compound; examples of the commercially-supplied products include PALIOCOLOR LC242 produced by BASF AG, E7 and RM 257 produced by Merck & Co., Inc., LC-SILICON-CC3767 produced by Wacker Chemie AG, and L35, L42, L55, L59, L63, L79 and L83 produced by Takasago International Corporation.

The content of the liquid crystal compound in the polarizing layer is not particularly limited and can be suitably selected according to the purpose; however, it is desirable that the content be 1% by mass to 90% by mass, more desirably 5% by mass to 50% by mass.

### <Metal Ion>

It is desirable that the metal ion be at least one ion selected from ions of silver, gold, copper, aluminum, palladium, rhodium, platinum, ruthenium, selenium, tellurium, cobalt and nickel. Amongst these, ions of gold, silver, copper and aluminum are particularly desirable.

For a metal ion source in the metal ion, a metal compound is suitable, for example.

Examples of the metal compound include a metal salt, a metal complex and an organic metal compound.

An acid forming the metal salt may be any one of an inorganic acid and an organic acid.

The inorganic acid is not particularly limited and can be suitably selected according to the purpose; examples thereof include nitric acid, and halogenated hydracids such as hydrochloric acid, hydrobromic acid and hydriodic acid.

The organic acid is not particularly limited and can be suitably selected according to the purpose; examples thereof include a carboxylic acid and a sulfonic acid.

Examples of the carboxylic acid include acetic acid, butyric acid, oxalic acid, stearic acid, behenic acid, lauric acid and benzoic acid.

Examples of the sulfonic acid include methylsulfonic acid.

A chelating agent forming the metal complex is not particularly limited and can be suitably selected according to the purpose; examples thereof include acetylacetonate and EDTA. Also, a complex may be formed by the metal salt and a ligand; examples of the ligand include imidazole, pyridine and phenylmethyl sulfide.

Note that examples of the metal compound include acids of halogenated complexes of metal ions (e.g. chloroauric acid and chloroplatinic acid), and alkali metal salts (e.g. sodium chloroaurate and sodium tetrachloropalladate).

### —Anisotropic Metal Nanoparticle—

The anisotropic metal nanoparticles are deposited by reduction of metal ions, and are nanosized rod-like metal fine particles of several nanometers to 100 nm in size. The rod-like metal fine particles refers to particles having an average aspect ratio (major-axis length/minor-axis length) of greater than 1.

It is desirable that the anisotropic metal nanoparticles have an average aspect ratio of greater than 1 and less than or equal to 100, more desirably in the range of 1.2 to 20.

Here, the aspect ratio of the anisotropic metal nanoparticle can be determined by measuring the major-axis length and minor-axis length of the anisotropic metal nanoparticle and substituting the values into the following equation: (major-axis length of anisotropic metal nanoparticle)/(minor-axis length of anisotropic metal nanoparticle).

The minor-axis length of the anisotropic metal nanoparticle is not particularly limited and can be suitably selected according to the purpose; however, it is preferably 1 nm to 50 nm, more preferably 3 nm to 30 nm. The major-axis length of the anisotropic metal nanoparticle is not particularly limited and can be suitably selected according to the purpose; however, it is preferably 5 nm to 1,000 nm, more preferably 10 nm to 300 nm.

Such an anisotropic metal nanoparticle exhibits surface plasmon resonance and absorption between the ultraviolet region and the infrared region. For example, since an anisotropic metal nanoparticle whose minor-axis length is 1 nm to 50 nm, major-axis length is 10 nm to 1,000 nm and aspect ratio is greater than 1 can have different absorption positions from the minor-axis direction to the major-axis direction, a film where such anisotropic metal nanoparticles are aligned exhibits anisotropic absorption and can therefore be used as a polarizing plate.

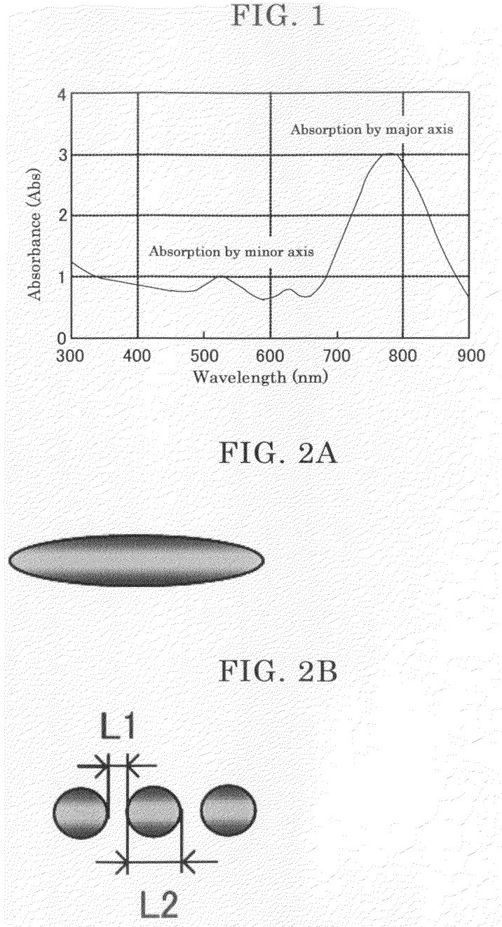

Here, FIG. 1 shows the absorption spectrum of an anisotropic metal nanoparticle whose minor-axis length is 12.4 nm and major-axis length is 45.5 nm. The wavelength at which absorption of such an anisotropic metal nanoparticle takes place in terms of minor axis is near 530 nm, showing a red color, whereas the wavelength at which absorption in terms of major axis takes place is near 780 nm, showing a deep blue color.

The shape of the anisotropic metal nanoparticle is not particularly limited as long as dichroism is expressed; besides the rod-like shape shown in FIG. 2A, the shape thereof may be a columnar shape, a quadrangular prism, a triangular prism, a hexagonal prism, a dog bone shape, or the like. Also, the anisotropic metal nanoparticle may be an aggregate composed of two or more substantially spherical metal nanoparticles; as shown in FIG. 2B, the aggregate composed of two or more roughly spherical metal nanoparticles means a particle in which two or more substantially spherical metal nanoparticles are in such a state as to satisfy the following expression: distance (L1) between metal nanoparticles≦metal nanoparticle diameter (L2).

The anisotropic metal nanoparticle is formed from at least one metal and preferably includes at least one element selected from silver, gold, copper, aluminum, palladium, rhodium, platinum, ruthenium, selenium, cobalt, tellurium and nickel, for example. Amongst these, gold, silver, copper and aluminum are particularly preferable.

### <Aligning Agent>

The type, additive amount and the like of an aligning agent are adjusted so as to bring the molecules of a liquid crystal compound into an alignment state of any one of substantially horizontal alignment, substantially vertical alignment, diagonal alignment and hybrid alignment in the polarizing layer. Examples of the aligning agent include the following vertical aligning agents and horizontal aligning agents.

### —Vertical Aligning Agent (Polymeric Surfactant)—

A liquid crystal layer formed on an alignment film provided on one side of a base may offer a spray alignment in which the liquid crystal molecules rise up from the alignment film side toward the air interface side, by making the terminal of liquid crystal molecules hydrophobic. However, if nothing is done, the liquid crystal molecules poorly rise up near the air interface side, and thus the force by which a polarizer is diagonally aligned is weak. Accordingly, when a polymeric surfactant which strongly interacts with the liquid crystal layer used is selected and added to the liquid crystal layer, the polymeric surfactant moves up toward the air interface side during liquid crystal alignment, thereby vertically aligning adjacent liquid crystals in a strong manner. Consequently, the overall liquid crystal molecules assumes the spray alignment (in other words diagonal alignment) in which liquid crystal molecules at the alignment film side are horizontally aligned while having a small pre-tilt angle and liquid crystal molecules are gradually vertically aligned toward the air interface side along the thickness direction.

A nonionic polymeric surfactant is favorable for the foregoing polymeric surfactant, and it is advisable to select one which strongly interacts with a liquid crystal compound used from commercially-supplied polymeric surfactants. Suitable examples thereof include MEGAFAC F780F produced by Dainippon Ink And Chemicals, Incorporated.

It is desirable that the content of the polymeric surfactant be 0.1% by mass to 8.0% by mass based on the total solid (mass) of an coating solution of the polarizing layer, more desirably 0.5% by mass to 5.0% by mass.

### —Horizontal Aligning Agent—

The horizontal aligning agent is not particularly limited and can be suitably selected according to the purpose; for example, it is virtually possible to horizontally align molecules of a liquid crystal compound by the horizontal aligning agent containing at least one of the compounds represented by General Formulae (1) to (3) below. As used herein, the term “horizontal alignment” means that in the case of a rod-like liquid crystal, its molecular major axis is parallel with a horizontal surface of a transparent support and that in the case of a disk-shaped liquid crystal, a disk surface of the core of a disk-shaped liquid crystal compound is parallel with a horizontal surface of a transparent support; however, strict parallelness is not required, and “horizontal alignment” in the present specification means that the molecular major axis or the disk surface is obliquely oriented at an angle of less than 10 deg. to the horizontal surface. It is desirable that the oblique angle be 0 deg. to 5 deg., more desirably 0 deg. to 3 deg., even more desirably 0 deg. to 2 deg., particularly desirably 0 deg. to 1 deg.

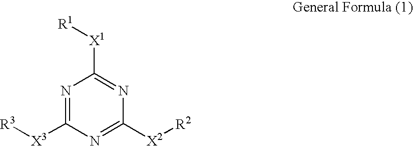

where R¹, R² and R³ may be identical or different from one another, with each denoting a hydrogen atom or a substituent; X¹, X² and X³ each denote a single bond or a divalent linkage group.

Examples of the substituents represented by R¹ to R³ include substituted or unsubstituted alkyl groups (in particular, unsubstituted alkyl groups or fluorine-substituted alkyl groups are preferable), substituted or unsubstituted aryl groups (in particular, aryl groups having fluorine-substituted alkyl groups are preferable), substituted or unsubstituted amino groups, substituted or unsubstituted alkoxy groups, substituted or unsubstituted alkylthio groups and halogen atoms.

It is desirable that the divalent linkage groups represented by X¹, X² and X³ be, for example, alkylene groups, alkenylene groups, divalent aromatic groups, divalent heterocyclic residues, —CO—, —NR³ (note that R³ denotes any one of alkyl groups having 1 to 5 carbon atoms, or a hydrogen atom), —O—, —S—, —SO—, —SO₂— and divalent linkage groups selected from combinations thereof.

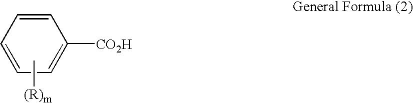

where R denotes a substituent, and m denotes an integer of 0 to 5. When m denotes an integer greater than or equal to 2, the plurality of Rs may be identical or different from one another.

A favorable range of substituents represented by R is the same as the range of substituents represented by R¹, R² and R³ in General Formula (1); m preferably denotes an integer of 1 to 3, more preferably either 2 or 3.

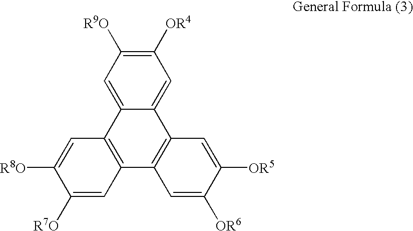

where R⁴, R⁵, R⁶, R⁷, R⁸ and R⁹ may be identical or different from one another, with each denoting a hydrogen atom or a substituent. Suitable examples of the substituents represented by R⁴ to R⁹ include substituted or unsubstituted alkyl groups (in particular, unsubstituted alkyl groups or fluorine-substituted alkyl groups are preferable) and aryl groups (in particular, aryl groups having fluorine-substituted alkyl groups are preferable).

The following shows specific examples of compounds which can be suitably applied to the horizontal aligning agent.

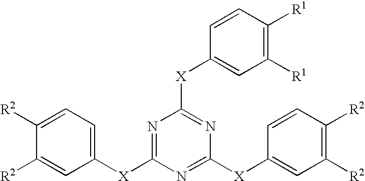

| Compound | | | |
|---|---|---|---|
| No. | R¹ | R² | X |
| I-1 | O(CH₂)₃(CF₂)₄F | O(CH₂)₃(CF₂)₄F | NH |
| I-2 | O(CH₂)₃(CF₂)₆F | O(CH₂)₃(CF₂)₆F | NH |
| I-3 | O(CH₂)₃(CF₂)₈F | O(CH₂)₃(CF₂)₈F | NH |
| I-4 | OCH₂(CF₂)₆H | OCH₂(CF₂)₆H | NH |
| I-5 | OCH₂(CF₂)₈H | OCH₂(CF₂)₈H | NH |
| I-6 | O(CH₂)₂O(CH₂)₂(CF₂)₆F | O(CH₂)₂O(CH₂)₂(CF₂)₆F | NH |
| I-7 | O(CH₂)₂O(CH₂)₂(CF₂)₄F | O(CH₂)₂O(CH₂)₂(CF₂)₄F | NH |
| I-8 | O(CH₂)₃S(CH₂)₂(CF₂)₆F | O(CH₂)₃S(CH₂)₂(CF₂)₆F | NH |
| I-9 | O(CH₂)₃S(CH₂)₂(CF₂)₄F | O(CH₂)₃S(CH₂)₂(CF₂)₄F | NH |
| I-10 | O(CH₂)₆S(CH₂)₂(CF₂)₆F | O(CH₂)₆S(CH₂)₂(CF₂)₆F | NH |
| I-11 | O(CH₂)₆S(CH₂)₂(CF₂)₄F | O(CH₂)₆S(CH₂)₂(CF₂)₄F | NH |
| I-12 | OC₁₀H₂₁ | OCH₂CH₂(CF₂)₄F | NH |
| I-13 | OC₁₂H₂₅ | OCH₂CH₂(CF₂)₄F | NH |
| I-14 | OC₈H₁₇ | OCH₂CH₂(CF₂)₆F | NH |
| I-15 | OC₁₆H₃₃ | OCH₂CH₂(CF₂)₆F | NH |
| I-16 | OC₁₂H₂₅ | OCH₂CH₂(CF₂)₆F | NH |
| I-17 | O(CH₂)₂O(CH₂)(CF₂)₆H | O(CH₂)₂O(CH₂)(CF₂)₆F | NH |
| I-18 | O(CH₂)₃(CF₂)₆F | O(CH₂)₃(CF₂)₆F | O |
| I-19 | OCH₂(CF₂)₆H | OCH₂(CF₂)₆H | O |
| I-20 | O(CH₂)₂O(CH₂)₂(CF₂)₆F | O(CH₂)₂O(CH₂)₂(CF₂)₆F | O |
| I-21 | O(CH₂)₃S(CH₂)₂(CF₂)₆F | O(CH₂)₃S(CH₂)₂(CF₂)₆F | O |
| I-22 | O(CH₂)₂O(CH₂)(CF₂)₆H | O(CH₂)₂O(CH₂)(CF₂)₆H | O |
| I-23 | O(CH₂)₃(CF₂)₆F | O(CH₂)₃(CF₂)₆F | S |
| I-24 | OCH₂(CF₂)₆H | OCH₂(CF₂)₆H | S |
| I-25 | O(CH₂)₂O(CH₂)₂(CF₂)₆F | O(CH₂)₂O(CH₂)₂(CF₂)₆F | S |
| I-26 | O(CH₂)₃S(CH₂)₂(CF₂)₆F | O(CH₂)₃S(CH₂)₂(CF₂)₆F | S |
| I-27 | O(CH₂)₂O(CH₂)(CF₂)₆H | O(CH₂)₂O(CH₂)(CF₂)₆H | S |

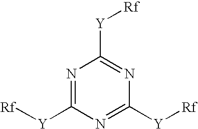

| Compound | | |
|---|---|---|
| No. | Rf | Y |
| I-28 | (CH₂)₂CF₂)₄F | O |
| I-29 | (CH₂)₂(CF₂)₆F | O |
| I-30 | (CH₂)₂(CF₂)₈F | O |
| I-31 | CH₂(CF₂)₆H | O |
| I-32 | CH₂(CF₂)₈H | O |
| I-33 | (CH₂)₂(CF₂)₆F | O(CH₂)₂O |
| I-34 | (CH₂)₂(CF₂)₄F | O(CH₂)₂O |
| I-35 | (CH₂)₂(CF₂)₆F | O(CH₂)₃S |
| I-36 | (CH₂)₂(CF₂)₆F | O(CH₂)₆S |
| I-37 | (CH₂)₃(CF₂)₆F | NH(CH₂)₃O |
| I-38 | CH₂(CF₂)₆H | NH(CH₂)₃O |
| I-39 | CH₂(CF₂)₈H | NH(CH₂)₃O |

where Y is bonded to a triazine ring and Rf.

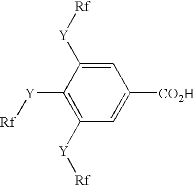

| Compound | | |
|---|---|---|
| No. | Rf | Y |
| I-40 | (CH₂)₃(CF₂)₄F | O |
| I-41 | (CH₂)₃(CF₂)₆F | O |
| I-42 | (CH₂)₃(CF₂)₈F | O |
| I-43 | CH₂(CF₂)₆H | O |
| I-44 | CH₂(CF₂)₈H | O |
| I-45 | (CH₂)₂(CF₂)₆F | O(CH₂)₂O |
| I-46 | (CH₂)₂(CF₂)₄F | O(CH₂)₂O |
| I-47 | (CH₂)₂(CF₂)₆F | O(CH₂)₃S |
| I-48 | (CH₂)₂(CF₂)₆F | O(CH₂)₆S |

where Y is bonded to a benzene ring and Rf.

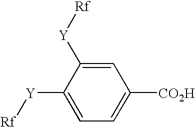

| Compound | | |
|---|---|---|
| No. | Rf | Y |
| I-49 | (CH₂)₃(CF₂)₆F | O |
| I-50 | (CH₂)₃(CF₂)₆F | O(CH₂)₂O |

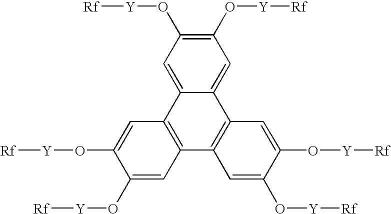

| Compound | | |
|---|---|---|
| No. | Rf | Y |
| I-51 | (CF₂)₄F | (CH₂)₃ |
| I-52 | (CF₂)₆F | (CH₂)₃ |
| I-53 | (CF₂)₈F | (CH₂)₃ |
| I-54 | (CF₂)₆H | CH₂ |
| I-55 | (CF₂)₈H | CH₂ |
| I-56 | (CH₂)₂(CF₂)₆F | (CH₂)₂O |
| I-57 | (CH₂)₂(CF₂)₄F | (CH₂)₂O |
| I-58 | (CH₂)₂(CF₂)₆F | (CH₂)₃S |
| I-59 | (CH₂)₂(CF₂)₆F | (CH₂)₆S |

where Y is bonded to an oxygen atom and Rf.

It is desirable that the additive amount of the compounds represented by General Formulae (1) to (3) be 0.01% by mass to 20% by mass to the mass of the liquid crystal compound, more desirably 0.01% by mass to 10% by mass, even more desirably 0.02% by mass to 1% by mass. Note that the compounds represented by General Formulae (1) to (3) may be used alone or in combination with two or more.

### —Polymerization Initiator—

The polymerization initiator is not particularly limited and can be suitably selected according to the type of a liquid crystal compound; however, a photopolymerization initiator is particularly favorable.

The photopolymerization initiator is not particularly limited and can be suitably selected from known photopolymerization initiators according to the purpose; examples thereof include p-methoxyphenyl-2,4-bis(trichloromethyl)-s-triazine, 2-(p-butoxystyryl)-5-trichloromethyl1,3,4-oxadiazole, 9-phenylacridine, 9,10-dimethylbenzphenazine, benzophenone/Michler's ketone, hexaarylbiimidazole/mercaptobenzimidazole, benzyldimethylketal and thioxanthone/amine. These may be used alone or in combination with two or more.

Commercially-supplied products can be used for the photopolymerization initiator; examples of the commercially-supplied product include the trade names IRGACURE 907, IRGACURE 369, IRGACURE 784 and IRGACURE 814 produced by Ciba Specialty Chemicals, and the trade name LUCIRIN TPO produced by BASF AG.

It is desirable that the content of the photopolymerization initiator in the polarizing layer be 0.1% by mass to 20% by mass, more desirably 0.5% by mass to 5% by mass.

### —Reduction—

The reduction is not particularly limited and can be suitably selected according to the purpose; examples thereof include thermal reduction, photoreduction and chemical reduction. The reduction may be composed of two or more types of reduction processes, and further, an external field such as an electric field or magnetic field may be applied at the time of reduction reaction. Amongst these reductions, photoreduction, thermal reduction and a combination of photoreduction and thermal reduction are particularly favorable.

The thermal reduction can be conducted using a hotplate, an oven, an infrared heater, a heat roller, vapor (hot air) or the like, for example, and it is conducted preferably at a temperature of 50° C. to 250° C., more preferably at a temperature of 50° C. to 150° C.

Examples of the photoreduction include ultraviolet irradiation, visible light irradiation and electron irradiation. Details of photoreduction will be explained in an after-mentioned method for producing a polarizing plate.

Examples of the chemical reduction include those using hydrogen gas, sodium borate hydride, hydrazine, ascorbic acid or amines.

It is also possible to add metal nanoparticles of 1 nm to 5 nm in average particle diameter as seed crystals to the polarizing layer according to necessity. Due to the addition of the seed crystals, the seed crystals become a catalytic core in a metal ion reduction reaction, and metal ions are efficiently reduced in the vicinity of the seed crystals, thereby making it possible to produce anisotropic metal nanoparticles which are large in aspect ratio and uniform in size.

Further, it is possible to add a particle form controlling agent to the polarizing layer according to necessity. The particle form controlling agent adsorbs onto one crystal face of an anisotropic metal nanoparticle generated and thus promotes or hinders growth of the one crystal face, thereby being capable of controlling the form of the anisotropic metal nanoparticle. Suitable examples thereof include sulfur-containing compounds having functional groups, such as thiol and disulfide; and nitrogen-containing compounds such as amine, quaternary ammonium salt and nitrogen-containing heterocyclic compounds.

The nitrogen-containing heterocyclic compounds are not particularly limited and can be suitably selected according to the purpose; examples thereof include the compounds described in the paragraphs [0028] to [0061] of JP-A No. 2006-284921.

### <Base>

The shape, structure, size and the like of the base are not particularly limited and can be suitably selected according to the purpose; examples of the shape include a plate-like shape and a sheet-like shape, and examples of the structure include a single-layer structure and a laminated structure, which can be suitably selected.

The material for the base is not particularly limited, and both inorganic materials and organic materials can be suitably applied to the base.

Examples of the inorganic material include glass, quartz and silicon.

Examples of the organic material include acetate-based resins such as triacetylcellulose (TAC), polyester resins, polyethersulfone resins, polysulfone resins, polycarbonate resins, polyamide resins, polyimide resins, polyolefin resins, acrylic resins, polynorbornene resins, cellulose resins, polyarylate resins, polystyrene resins, polyvinyl alcohol resins, polyvinyl chloride resins, polyvinylidene chloride resins and polyacrylic resins. These may be used alone or in combination with two or more.

The base may be suitably synthesized, or a commercially-supplied product may be used for the base.

The thickness of the base is not particularly limited and can be suitably selected according to the purpose, and it is preferably 10 μm to 2,000 μm, more preferably 50 μm to 500 μm.

### <Alignment Film>

For the alignment film, an alignment film that has been subjected to rubbing treatment is suitable. The rubbing treatment involves depositing on a surface of a base a film formed of polyimide, polyamide-imide, polyetherimide, polyvinyl alcohol or the like, and rubbing a surface of the film for alignment. The rubbing alignment process is a process in which a drum with a short-hair velvety cloth of rayon, cotton, etc. wound around it is brought into contact with the surface of an alignment film while being rotated. The alignment film which has undergone the rubbing treatment is provided with minute grooves in its surface that run in one direction, and thus liquid crystal molecules which are in contact with the minute grooves can be aligned in one direction.

The alignment film may be produced by a photo-alignment process besides the rubbing treatment. The photo-alignment process involves forming a photo-alignment film containing a photoactive molecule such as an azobenzene-based polymer or polyvinyl cinnamate on the surface of a base, and irradiating the photo-alignment film with a linearly polarized light or diagonal unpolarized light which has such a wavelength as makes the photoactive molecule produce photochemical reaction, so as to yield anisotropy on the surface of the photo-alignment film. As to the photo-alignment film which has undergone the photo-alignment process, a molecular major axis on the uppermost surface thereof is aligned by an incident light, and liquid crystal molecules which are in contact with molecules on the uppermost surface can thus be aligned.

Besides the azobenzene-based polymer, polyvinyl cinnamate, etc., a suitable material can be selected according to the purpose as the material for the photo-alignment film without any limitation in particular as long as it can yield anisotropy on the film surface by means of any reaction selected from photoisomerization, photodimerization, photocyclization, photocrosslinking, photolysis and photolysis-bonding that utilize the application of a linear polarized light or diagonal unpolarized light having such a wavelength as makes a photoactive molecule produce photochemical reaction; examples thereof include the photo-alignment film materials described in “Ekisho Vol. 3 No. 1, p. 3 (Masaki Hasegawa) published by Japanese Liquid Crystal Society in 1999” and “Ekisho Vol. 3 No. 4, p. 262 (Yasumasa Takeuchi) published by Japanese Liquid Crystal Society in 1999”.

When liquid crystals are applied onto the alignment film, the liquid crystal molecules are aligned by means of at least either the driving force effected by alignment of molecules in the minute grooves in the surface of the alignment film, or the driving force effected by alignment of molecules on the uppermost surface thereof.

As explained above, the polarizing plate of the present invention includes a polarizing layer containing anisotropic metal nanoparticles produced by reducing a metal ion in a liquid crystal matrix, wherein the liquid crystal matrix is characterized in that molecules of a liquid crystal compound are fixed in an alignment state of any one of substantially horizontal alignment, substantially vertical alignment, diagonal alignment, hybrid alignment and spiral alignment, and the anisotropic metal nanoparticles are aligned in the alignment direction of the liquid crystal molecules. And the polarizing plate can be efficiently produced by the method of the present invention for producing a polarizing plate, which will be explained below.

### (Method for Producing Polarizing Plate)

The method of the present invention for producing a polarizing plate includes: forming a liquid crystal film where molecules of the liquid crystal compound are fixed in an alignment state by applying a liquid crystal composition containing at least a liquid crystal compound onto a base whose surface is provided with an alignment film and by curing the liquid crystal composition; impregnating the liquid crystal film with a metal ion; and reducing the metal ion in the liquid crystal film so as to form anisotropic metal nanoparticles. And the method further includes additional step(s) according to necessity.

It should be noted that as to the method of the present invention, it is also possible to produce a polarizing plate by a method including forming a liquid crystal coating film having aligned molecules of the liquid crystal compound by applying a liquid crystal composition containing at least a liquid crystal compound and a metal ion onto a base whose surface is provided with an alignment film; and reducing the metal ion at the same time when the liquid crystal coating film is cured, so as to form anisotropic metal nanoparticles.

### <Liquid Crystal Film Forming Step>

The liquid crystal film forming step is a step of forming a liquid crystal film where molecules of the liquid crystal compound are fixed in an alignment state by applying a liquid crystal composition containing at least a liquid crystal compound onto a base whose surface is provided with an alignment film and by curing the liquid crystal composition.

In the liquid crystal film forming step, a resin composition which contains at least a liquid crystal compound, contains a solvent, and further contains an aligning agent according to necessity, is applied onto a base and dried so as to form a liquid crystal coating film.

For the base, the alignment film, the liquid crystal compound and the aligning agent, the above-mentioned ones can be used.

The solvent is not particularly limited and can be suitably selected according to the purpose; examples thereof include halogenated hydrocarbons such as chloroform, dichloromethane, carbon tetrachloride, dichloroethane, tetrachloroethane, methylene chloride, trichloroethylene, tetrachloroethylene, chlorobenzene and orthodichlorobenzene; phenols such as phenol, p-chlorophenol, o-chlorophenol, m-cresol, o-cresol and p-cresol; aromatic hydrocarbons such as benzene, toluene, xylene, methoxybenzene and 1,2-dimethoxybenzene; ketone-based solvents such as acetone, methyl ethyl ketone (MEK), methyl isobutyl ketone, cyclohexanone, cyclopentanone, 2-pyrrolidone and N-methyl-2-pyrrolidone; ester-based solvents such as ethyl acetate and butyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol and 2-methyl-2,4-pentanediol; amide-based solvents such as dimethylformamide and dimethylacetamide; nitrile-based solvents such as acetonitrile and butyronitrile; ether-based solvents such as diethyl ether, dibutyl ether, tetrahydrofuran and dioxane; carbon disulfide, ethyl cellosolve and butyl cellosolve. These may be used alone or in combination with two or more.

Examples of the coating method include spin coating, casting, roll coating, flow coating, printing, dip coating, casting deposition, bar coating, and gravure printing.

The curing may be thermal curing or photocuring, with photocuring being particularly favorable.

### <Impregnating Step>

Examples of the impregnating process include (1) a process of immersing a liquid crystal film in a solution containing at least a metal ion, and (2) a process of applying a solution containing at least a metal ion onto a liquid crystal film surface. Additionally, it is desirable that when the immersion or the application is carried out, the liquid crystal film be swollen beforehand in the solution.

### <Reducing Step>

The reducing step is a step of reducing a metal ion in a liquid crystal film to form anisotropic metal nanoparticles.

The reduction is at least one of photoreduction, thermal reduction and chemical reduction and can be a combination thereof. Amongst these reductions, photoreduction is particularly favorable.

Examples of light for use in the photoreduction include visible light, ultraviolet light, near-infrared light, X-ray and electron beam. Amongst these, ultraviolet light is particularly favorable.

Conditions of the ultraviolet irradiation are not particularly limited and can be suitably selected according to the purpose; for example, it is desirable that the wavelength of an ultraviolet light applied be 160 nm to 380 nm, more desirably 250 nm to 380 nm. It is desirable that the irradiation energy be 1 mW/cm² to 10,000 mW/cm² and the irradiation time be 1 sec to 600 min.

Examples of a light source of the ultraviolet light include low-pressure mercury vapor lamps (bactericidal lamp, fluorescent chemical lamp and black light), high-pressure discharge lamps (high-pressure mercury vapor lamp and metal halide lamp) and short-arc discharge lamps (extra-high-pressure mercury vapor lamp, xenon lamp and mercury xenon lamp).

Additionally, a light applied may be a polarized light. It is desirable that the polarized light be a linearly polarized light.

The polarized light is applied in accordance with a conventional method, for example a method of using the light source and a polarizing plate of iodine, dichroic dye, a wire grid, etc., a method of using a polarizing transmission filter utilizing Brewster's angle, a method of using a Glan-Thompson prism, or a method of using a laser light having polarizing properties.

When metal ions are reduced in the reducing step, anisotropic metal nanoparticles whose major axis orients the alignment direction of the liquid crystal molecules of the liquid crystal matrix are deposited. Therefore, substantially horizontally aligned anisotropic metal nanoparticles are deposited in a substantially horizontally aligned curable liquid crystal area, diagonally aligned anisotropic metal nanoparticles are deposited in a diagonally aligned curable liquid crystal area, and substantially vertically aligned anisotropic metal nanoparticles are deposited in a substantially vertically aligned curable liquid crystal area. It is possible to select any of these alignment forms by selecting an appropriate aligning agent added and/or by adjusting the added amount of the aligning agent.

As the additional step, it is desirable to conduct a baking treatment as a subsequent step so as to improve film durability.

The polarizing plate of the present invention includes anisotropic metal nanoparticles having an average aspect ratio of greater than 1, wherein the major axis of the anisotropic metal nanoparticles is aligned in the alignment direction of molecules of a liquid crystal compound in a liquid crystal matrix; hence the polarizing plate has superior polarizing properties over a wide wavelength range.

It is desirable that the major axis of the anisotropic metal nanoparticles be aligned in any one of a substantially horizontal direction, a substantially vertical direction, a diagonal direction, a hybrid direction and a spiral direction, with respect to a base surface, more desirably either a substantially horizontal direction or substantially vertical direction with respect to the base surface.

The term “substantially vertical direction” means that the major axis of an anisotropic metal nanoparticle is aligned at an angle of 80 deg. to 90 deg. to the base surface, preferably at an angle of 85 deg. to 90 deg., more preferably at an angle of 90 deg. (vertically aligned).

The term “diagonal direction” means that the major axis of an anisotropic metal nanoparticle is aligned at an angle of greater than or equal to +20 deg. and less than +80 deg. to the base surface, preferably at an angle of greater than or equal to +30 deg. and less than or equal to +70 deg.

The term “substantially horizontal direction” means that the major axis of an anisotropic metal nanoparticle is aligned at an angle of less than +20 deg. to the base surface, preferably aligned at an angle of less than or equal to +10 deg., more preferably aligned at an angle of less than or equal to +5 deg., even more preferably aligned at an angle of 0 deg. (horizontally aligned).

Here, whether the major axis of an anisotropic metal nanoparticle is aligned in any one of a substantially horizontal direction, a substantially vertical direction, a diagonal direction, a hybrid direction and a spiral direction, with respect to the base surface can be confirmed, for example by observing a cross-section of the polarizing plate using a transmission electron microscope (TEM).

### —Uses—

The polarizing plate of the present invention can be applied, for example, to projectors, liquid crystal monitors, liquid crystal televisions and the like. Furthermore, it can be used in a variety of fields including optical isolators, optical fibers, glasses for vehicles such as automobiles, buses, trucks, trains, high-speed trains, airplanes, passenger planes and ships, and glasses for building materials used for openings, partitions, etc. of buildings such as conventional detached houses, apartment buildings, office buildings, shops, public facilities and factories.

According to the present invention, it is possible to solve problems in related art and provide a polarizing plate which has superior polarizing properties over a wide wavelength range and which is superior in weather resistance, and a method for producing the polarizing plate inexpensively and efficiently.

### EXAMPLES

The following explains Examples of the present invention; however, it should be noted that the present invention is not confined to these Examples in any way.

### Example 1

### —Production of Polarizing Plate—

To a liquid crystal solution prepared by dissolving 3.04 g of a liquid crystal compound (PALIOCOLOR LC242 produced by BASF AG) having photopolymerizable groups and 0.1 g of a horizontal aligning agent represented by the structural formula below in 5.07 g of methyl ethyl ketone (MEK) was added 1.11 g of an polymerization initiator solution prepared by dissolving 0.90 g of IRGACURE 907 (produced by Ciba Specialty Chemicals) and 0.30 g of KAYACURE DETX (produced by Nippon Kayaku Co., Ltd.) in 8.80 g of methyl ethyl ketone (MEK), and the ingredients were completely dissolved by means of agitation for 5 min. In this way a coating solution was prepared.

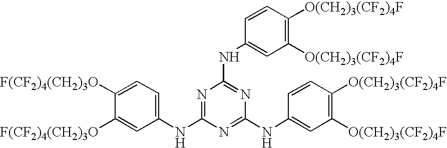

Next, onto a side of a 100 mm×100 mm base film (TD80U produced by FUJIFIL) where a PVA alignment film was to be provided, 10 mass % aqueous solution of polyvinyl alcohol (MP203 produced by Kuraray Co., Ltd.) was applied by spin coating at 500 rpm for 15 sec, and dried.

Then a PVA alignment film was produced by rubbing the PVA film side twice with a rubbing apparatus (produced by Joyo Engineering Co., Ltd.; 1,000 rpm in rotational speed and 0.35 mm in indentation amount).

Subsequently, the coating solution was applied by spin coating onto the PVA alignment film at 1,000 rpm for 20 sec and placed on a hotplate, with the surface opposite to the coating surface brought into contact with the hotplate, and the coating solution was heated at 90° C. for 1 min and then irradiated with an ultraviolet (UV) ray (a mercury xenon lamp, 200 W, 73 mJ/cm²) in a heated state. A liquid crystal cured film in which liquid crystal molecules were uniaxially aligned in the rubbing direction was thus obtained.

HAuCl₄.3H₂O (produced by Kanto Chemical Co., Inc) in methyl ethyl ketone solution (5 mass %) was applied by spin coating onto a surface of the obtained liquid crystal cured film at 1,000 rpm for 30 sec and placed on a hotplate, with the surface opposite to the coating surface brought into contact with the hotplate, and the solution was irradiated with an ultraviolet (UV) ray (a mercury xenon lamp, 200 W, 876 mJ/cm²) in a heated state at 90° C. A polarizing plate of Example 1 was thus produced.

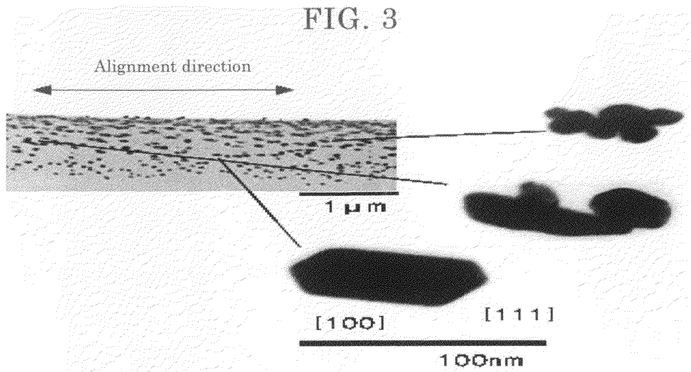

When a section of the polarizing plate of Example 1 obtained was observed using a transmission electron microscope (TEM) (JEM-2010 produced by JEOL Ltd.), Au nanorods were aligned parallel to the base rubbing direction and also aligned in a substantially horizontal direction with respect to the base surface, as shown in FIG. 3. The Au nanorods had an average aspect ratio (major-axis length/minor-axis length) of 2.5.

### Example 2

### —Production of Polarizing Plate—

A polarizing plate of Example 2 was produced in a manner similar to that in Example 1, except that AgNO₃ (produced by Kanto Chemical Co., Inc) in dimethylacetamide solution (5 mass %) was applied by spin coating onto the surface of the liquid crystal cured film in Example 1 at 1,000 rpm for 30 sec and placed on a hotplate, with the surface opposite to the coating solution brought into contact with the hotplate, and the solution was irradiated with an ultraviolet (UV) ray (a mercury xenon lamp, 200 W, 876 mJ/cm²) in a heated state at 90° C.

When a section of the polarizing plate of Example 2 obtained was observed using a transmission electron microscope (TEM) (JEM-2010 produced by JEOL Ltd.), Ag nanorods were aligned parallel to the base rubbing direction and also aligned in substantially horizontal direction with respect to a base surface. The Ag nanorods had an average aspect ratio of 2.7.

### Example 3

### —Production of Polarizing Plate—

To a liquid crystal solution prepared by dissolving 3.04 g of a liquid crystal compound (PALIOCOLOR LC242 produced by BASF AG) having photopolymerizable groups and 0.1 g of a polymeric surfactant (MEGAFAC F780F produced by Dainippon Ink And Chemicals, Incorporated) in 5.07 g of methyl ethyl ketone (MEK) was added 1.11 g of an polymerization initiator solution prepared by dissolving 0.90 g of IRGACURE 907 (produced by Ciba Specialty Chemicals) and 0.30 g of KAYACURE DETX (produced by Nippon Kayaku Co., Ltd.) in 8.80 g of methyl ethyl ketone (MEK), and the ingredients were completely dissolved by means of agitation for 5 min. In this way an coating solution was prepared.

Next, onto a side of a 100 mm×100 mm base film (TD80U produced by FUJIFIL) where a PVA alignment film was to be provided, 10 mass % aqueous solution of polyvinyl alcohol (MP203 produced by Kuraray Co., Ltd.) was applied by spin coating at 500 rpm for 15 sec, and dried.

Then a PVA alignment film was produced by rubbing the PVA film side twice with a rubbing apparatus (produced by Joyo Engineering Co., Ltd.; 1,000 rpm in rotational speed and 0.35 mm in indentation amount).

Subsequently, the coating solution was applied by spin coating onto the PVA alignment film at 1,000 rpm for 20 sec and placed on a hotplate, with the surface opposite to the coating surface brought into contact with the hotplate, and the coating solution was heated at 90° C. for 1 min and then irradiated with an ultraviolet (UV) ray (a mercury xenon lamp, 200 W, 73 mJ/cm²) in a heated state. In this way a liquid crystal cured film in which liquid crystal molecules were uniaxially aligned in the rubbing direction was obtained.

HAuCl₄.3H₂O (produced by Kanto Chemical Co., Inc) in methyl ethyl ketone solution (5 mass %) was applied by spin coating onto a surface of the obtained liquid crystal cured film at 1,000 rpm for 30 sec and placed on a hotplate, with the surface opposite to the coating surface brought into contact with the hotplate, and the solution was irradiated with an ultraviolet (UV) ray (a mercury xenon lamp, 200 W, 876 mJ/cm²) in a heated state at 90° C. A polarizing plate of Example 3 was thus produced.

When a section of the polarizing plate of Example 3 obtained was observed using a transmission electron microscope (TEM) (JEM-2010 produced by JEOL Ltd.), Au nanorods were aligned in a substantially vertical direction with respect to a base surface. The Au nanorods had an average aspect ratio of 2.6.

### Example 4

### —Production and Evaluation of Polarizing Plate—

A polarizing plate of Example 4 was produced in a manner similar to that in Example 3, except that AgNO₃ (produced by Kanto Chemical Co., Inc) in dimethylacetamide solution (5 mass %) was applied by spin coating onto the surface of the liquid crystal cured film in Example 3 at 1,000 rpm for 30 sec, and placed on a hotplate, with the surface opposite to the coating surface brought into contact with the hotplate, and the solution was irradiated with an ultraviolet (UV) ray (a mercury xenon lamp, 200 W, 876 mJ/cm²) in a heated state at 90° C.

When a section of the polarizing plate of Example 4 obtained was observed using a transmission electron microscope (TEM) (JEM-2010 produced by JEOL Ltd.), Ag nanorods were aligned in a substantially vertical direction with respect to a base surface. The Ag nanorods had an average aspect ratio of 2.8.

### Example 5

### —Production and Evaluation of Polarizing Plate—

A polarizing plate of Example 5 was produced in a manner similar to that in Example 1, except that the liquid crystal compound was changed from LC242 to RM257 (produced by Merck & Co., Inc.) in Example 1.

When a section of the polarizing plate of Example 5 obtained was observed using a transmission electron microscope (TEM) (JEM-2010 produced by JEOL Ltd.), Au nanorods were aligned parallel to the base rubbing direction and also aligned in a substantially horizontal direction with respect to a base surface. The Au nanorods had an average aspect ratio of 2.7.

### Example 6

### —Production and Evaluation of Polarizing Plate—

A polarizing plate of Example 6 was produced in a similar manner to Example 2, except that the liquid crystal compound was changed from LC242 to RM257 (produced by Merck & Co., Inc.) in Example 2.

When a section of the polarizing plate of Example 6 obtained was observed using a transmission electron microscope (TEM) (JEM-2010 produced by JEOL Ltd.), Ag nanorods were aligned parallel to the base rubbing direction and also aligned in a substantially horizontal direction with respect to a base surface. The Ag nanorods had an average aspect ratio of 2.9.

### Example 7

### —Production and Evaluation of Polarizing Plate—

A polarizing plate of Example 7 was produced in a manner similar to that in Example 3, except that the liquid crystal compound was changed from LC242 to RM257 (produced by Merck & Co., Inc.) in Example 3.

When a section of the polarizing plate of Example 7 obtained was observed using a transmission electron microscope (TEM) (JEM-2010 produced by JEOL Ltd.), Au nanorods were aligned in a substantially vertical direction with respect to a base surface. The Au nanorods had an average aspect ratio of 2.5.

### Example 8

### —Production and Evaluation of Polarizing Plate—

A polarizing plate of Example 8 was produced in a manner similar to Example 4, except that the liquid crystal compound was changed from LC242 to RM257 (produced by Merck & Co., Inc.) in Example 4.

When a section of the polarizing plate of Example 8 obtained was observed using a transmission electron microscope (TEM) (JEM-2010 produced by JEOL Ltd.), Ag nanorods were aligned in a substantially vertical direction with respect to a base surface. The Ag nanorods had an average aspect ratio of 2.8.

### Example 9

### —Production of Polarizing Plate—

A polarizing plate of Example 9 was produced in a manner similar to that in Example 1, except that HAuCl₄.3H₂O (produced by Kanto Chemical Co., Inc) in methyl ethyl ketone solution (5 mass %) was applied by spin coating onto the surface of the liquid crystal cured film in Example 1 at 1,000 rpm for 30 sec, and the solution was irradiated with an ultraviolet (UV) ray (a mercury xenon lamp, 200 W, 13140 mJ/cm²) at 20° C.

When a section of the polarizing plate of Example 9 obtained was observed using a transmission electron microscope (TEM) (JEM-2010 produced by JEOL Ltd.), Au nanorods were aligned parallel to the base rubbing direction and also aligned in a substantially horizontal direction with respect to the base surface. The Au nanorods had an average aspect ratio of 2.1.

### Comparative Example 1

A polarizing plate containing spherical silver ultrafine particles was produced in accordance with the procedures of Examples 3 and 4 described in the paragraphs [0123] to [0128] of JP-A No. 2004-212942.

### Comparative Example 2

A commercially-supplied iodine-PVA type polarizing plate (produced by Sanritz Corporation) was prepared.

### <Polarizing Property Evaluation of Polarizing Plate>

The polarizing transmission spectrum of each of the polarizing plates of Examples 1, 2, 5, 6 and 9 and Comparative Examples 1 and 2 was measured using a UV/VIS/NIR spectrophotometer (V-570 produced by JASCO Corporation). For evaluation of polarizing properties, the polarizing transmission spectrum (MD spectrum) in the case where an incident polarization plane was parallel to the alignment direction of the polarizing plate, and the polarizing transmission spectrum (TD spectrum) in the case where the incident polarization plane was perpendicular to the alignment direction of the polarizing plate were both measured by placing a VIS-NIR Glan-Taylor polarizer, sold as a window plate by JASCO Corporation and each polarizing plate and by rotating the Glan-Taylor polarizer, and the extinction ratio was calculated using Equation 1 below. The results are shown in Table 1.

Extinction ratio (dB)=10×log(Tₘₐₓ/Tₘᵢₙ) <Equation 1>

where Tₘₐₓ denotes the transmittance obtained from the TD spectrum, and Tₘᵢₙ denotes the transmittance obtained from the MD spectrum.

### <Dichroism Evaluation of Polarizing Plate>

The vertical polarizing plates of Examples 3, 4, 7 and 8 were evaluated for the dependence of absorption spectrum to the incident angle by using a UV/VIS/NIR spectrophotometer (V-570 produced by JASCO Corporation). The absorption spectrum at the time when the polarizing plate was placed perpendicularly to the optical axis of the spectrophotometer, and the absorption spectrum at the time when the polarizing plate was placed such that the angle between the horizontal surface and the optical axis of the spectrophotometer was 45° were measured, and the dichroic ratio was calculated using Equation 2 below. The results are shown in Table 2.

Dichroic ratio=Aₘₐₓ/Aₘᵢₙ <Equation 2>

where Aₘₐₓ denotes the absorbance when the polarizing plate horizontal surface is set at an angle of 45° to the optical axis, and Aₘᵢₙ denotes the absorbance when it is set perpendicularly to the optical axis.

### <Evaluation of Weather Resistance>

Weather resistance tests were carried out using SUNSHINE WEATHER METER (produced by Suga Test Instruments Co., Ltd.), in which the weather resistance of each polarizing plate was evaluated according to changes in the extinction ratio and the dichroic ratio after 1,000 hours. The results are shown in Tables 1 and 2.

TABLE 1

| | | Weather resistance |
|---|---|---|
| | Initial | test after 1,000 hr |
| Example 1 | 19.4 dB (800 nm) | 19.4 dB (800 nm) |
| Example 2 | 19.6 dB (800 nm) | 19.5 dB (800 nm) |
| Example 5 | 18.3 dB (800 nm) | 18.3 dB (800 nm) |
| Example 6 | 19.5 dB (800 nm) | 19.3 dB (800 nm) |
| Example 9 | 16.5 dB (650 nm) | 16.3 dB (650 nm) |
| Comparative Example 1 | 3.1 dB (440 nm) | 3.1 dB (440 nm) |
| Comparative Example 2 | 29.9 dB (650 nm) | 2.9 dB (650 nm) |

TABLE 2

| | | Weather resistance |
|---|---|---|
| | Initial | test after 1,000 hr |
| Example 3 | 7.9 (800 nm) | 7.9 (800 nm) |
| Example 4 | 8.3 (800 nm) | 8.1 (800 nm) |
| Example 7 | 7.3 (800 nm) | 7.3 (800 nm) |
| Example 8 | 7.7 (800 nm) | 7.5 (800 nm) |

Since the polarizing plate of the present invention has superior polarizing properties over a wide wavelength range and is superior in weather resistance, it can be applied, for example, to projectors, liquid crystal monitors, liquid crystal televisions and the like. Furthermore, it can be used in a variety of fields including optical isolators, optical fibers, glasses for vehicles such as automobiles, buses, trucks, trains, high-speed trains, airplanes, passenger planes and ships, and glasses for building materials used for openings, partitions, etc. of buildings such as conventional detached houses, apartment buildings, office buildings, shops, public facilities and factories.

What is claimed is:

1. A polarizing plate comprising:
a polarizing layer containing anisotropic metal nanoparticles produced by reducing a metal ion in a liquid crystal matrix.

2. The polarizing plate according to claim 1, wherein in the liquid crystal matrix molecules of a liquid crystal compound are fixed in an alignment state of any one of a substantially horizontal alignment, substantially vertical alignment, diagonal alignment, hybrid alignment and spiral alignment.

3. The polarizing plate according to claim 1, wherein the reduction is at least one of photoreduction, thermal reduction and chemical reduction.

4. The polarizing plate according to claim 2, wherein the anisotropic metal nanoparticles have an average aspect ratio of greater than 1, and the major axis of the anisotropic metal nanoparticles is aligned in the alignment direction of the molecules of the liquid crystal compound in the liquid crystal matrix.

5. The polarizing plate according to claim 1, wherein the anisotropic metal nanoparticle is an aggregate composed of two or more substantially spherical metal nanoparticles.

6. The polarizing plate according to claim 1, wherein the anisotropic metal nanoparticle comprises at least one element selected from silver, gold, copper, aluminum, palladium, rhodium, platinum, ruthenium, selenium, tellurium, cobalt and nickel.

7. The polarizing plate according to claim 1, comprising a base and a polarizing layer on the base, wherein the major axis of the anisotropic metal nanoparticles is aligned in any one of a substantially horizontal direction, substantially vertical direction, diagonal direction, hybrid direction and spiral direction, with respect to a base surface.

8. The polarizing plate according to claim 7, wherein the major axis of the anisotropic metal nanoparticles is aligned in any one of the substantially horizontal direction and substantially vertical direction, with respect to the base surface.

9. A method for producing a polarizing plate, comprising:
forming a liquid crystal film where molecules of the liquid crystal compound are fixed in an alignment state by applying a liquid crystal composition containing at least a liquid crystal compound onto a base whose surface is provided with an alignment film and by curing the liquid crystal composition,
impregnating the liquid crystal film with a metal ion, and
reducing the metal ion in the liquid crystal film so as to form anisotropic metal nanoparticles.

10. The method for producing a polarizing plate according to claim 9, wherein the reduction is at least one of photoreduction, thermal reduction and chemical reduction.
